(19) United States
(12) Patent Application Publication
(10) Pub. No.: US 2017/0064275 A1
(43) Pub. Date: Mar. 2, 2017

(54) IMAGE PROCESSING METHOD APPLIED TO AN RGB-IR SENSOR AND RELATED IMAGE PROCESSING DEVICE THEREOF

(71) Applicant: eYs3D Microelectronics, Co., TAIPEI CITY (TW)

(72) Inventors: Yung-Wei Chen, Taipei City (TW); Chi-Feng Lee, Hsinchu County (TW)

(21) Appl. No.: 15/242,617

(22) Filed: Aug. 22, 2016

(30) Foreign Application Priority Data
Aug. 24, 2015 (TW) 104127459

(51) Int. Cl. H04N 9/67; H04N 9/68; H04N 9/64; H04N 9/04; H04N 5/33

(52) U.S. Cl. CPC H04N 9/67; H04N 9/045; H04N 5/332; H04N 9/646; H04N 9/68; H04N 1/6008

(57) ABSTRACT

An image processing device applied to an RGB-IR sensor includes an interpolation unit and a color correction unit. Pixels included in the RGB-IR sensor are arranged into a plurality of bayer pattern units. The interpolation unit generates interpolation values of a red color component, a green color component, a blue color component, and an IR component of each pixel of each bayer pattern unit of the plurality of bayer pattern units according to gray levels of red pixels, green pixels, blue pixels, and IR pixels located in predetermined positions of the plurality of bayer pattern units. The color correction unit generates correction values of the red color component, the green color component, and the blue color component of the each pixel according to a correction matrix corresponding to the each pixel and the interpolation values.

### BACKGROUND OF THE INVENTION

1. Field of the Invention

The present invention relates to an image processing method applied to an RGB-IR sensor and a related device thereof, and particularly to an image processing method applied to an RGB-IR sensor and a related device thereof that cannot filter an IR component of each pixel of a plurality of pixels corresponding to the RGB-IR sensor.

2. Description of the Prior Art

Please refer to FIG. 1. FIG. 1 is a diagram illustrating pixels included in an RGB-IR sensor being arranged into a plurality of bayer pattern units, wherein each bayer pattern unit of the plurality of bayer pattern units includes a red pixel, a green pixel, a blue pixel, and an IR pixel. For example, as shown in FIG. 1, a bayer pattern unit 102 includes a red pixel 1022, a green pixel 1024, a blue pixel 1026, and an IR pixel 1028, wherein the red pixel 1022, the green pixel 1024, the blue pixel 1026, and the IR pixel 1028 can generate corresponding sensing values, respectively, and other red pixels, green pixels, blue pixels, and IR pixels included in the plurality of bayer pattern units are represented as R, G, B, IR, respectively. When the RGB-IR sensor does not have an IR filtering function, an image processing device coupled to the RGB-IR sensor can generate a substitute to substitute for a sensing value sensed by the IR pixel of the each bayer pattern unit according to sensing values sensed by the red pixel, the green pixel, and the blue pixel of the each bayer pattern unit. For example, the image processing device can generate an average to substitute for the sensing value sensed by the IR pixel of the each bayer pattern unit according to the sensing values sensed by the red pixel, the green pixel, and the blue pixel of the each bayer pattern unit.

Because the RGB-IR sensor does not have the IR filtering function, the sensing values sensed by the red pixel, the green pixel, and the blue pixel of the each bayer pattern unit still have IR components according to spectrums corresponding to the sensing values sensed by the red pixel, the green pixel, and the blue pixel of the each bayer pattern unit. That is to say, the RGB-IR sensor does not filter the IR components included in the sensing values sensed by the red pixel, the green pixel, and the blue pixel of the each bayer pattern unit. Therefore, although the image processing device coupled to the RGB-IR sensor can generate the substitute to substitute for the sensing value sensed by the IR pixel of the each bayer pattern unit according to the sensing values sensed by the red pixel, the green pixel, and the blue pixel of the each bayer pattern unit, because the sensing values sensed by the red pixel, the green pixel, and the blue pixel of the each bayer pattern unit and the substitute still have IR components, images generated by the image processing device according to the plurality of bayer pattern units have disadvantages of low color saturation and missing some colors.

### SUMMARY OF THE INVENTION

An embodiment of the present invention provides an image processing device applied to an RGB-IR sensor, wherein pixels included in the RGB-IR sensor are arranged into a plurality of bayer pattern units, and each bayer pattern unit of the plurality of bayer pattern units includes a red pixel, a green pixel, a blue pixel, and an IR pixel. The image processing device includes an interpolator and a color corrector. The interpolator is used for generating interpolation values of a red color component, a green color component, a blue color component, and an IR component of each pixel of the each bayer pattern unit according to gray levels of red pixels, green pixels, blue pixels, and IR pixels located in predetermined positions of the plurality of bayer pattern units. The color corrector is used for generating correction values of the red color component, the green color component, and the blue color component of the each pixel according to a correction matrix corresponding to the each pixel and the interpolation values of the red color component, the green color component, the blue color component, and the IR component of the each pixel, wherein the correction matrix corresponds to the interpolation values of the red color component, the green color component, the blue color component, and the IR component of the each pixel and target values of the red color component, the green color component, and the blue color component of the each pixel.

Another embodiment of the present invention provides an image processing method applied to an RGB-IR sensor, wherein pixels included in the RGB-IR sensor are arranged into a plurality of bayer pattern units, each bayer pattern unit of the plurality of bayer pattern units includes a red pixel, a green pixel, a blue pixel, and an IR pixel, and an image processing device applied to the image processing method includes an interpolator and a color corrector. The image processing method includes the interpolator generating interpolation values of a red color component, a green color component, a blue color component, and an IR component of each pixel of the each bayer pattern unit according to gray levels of red pixels, green pixels, blue pixels, and IR pixels located in predetermined positions of the plurality of bayer pattern units; and the color corrector generating correction values of the red color component, the green color component, and the blue color component of the each pixel according to a correction matrix corresponding to the each pixel and the interpolation values of the red color component, the green color component, the blue color component, and the IR component of the each pixel, wherein the correction matrix corresponds to the interpolation values of the red color component, the green color component, the blue color component, and the IR component of the each pixel and target values of the red color component, the green color component, and the blue color component of the each pixel.

The present invention provides an image processing method applied to an RGB-IR sensor and a related image processing device thereof. The image processing method and the image processing device utilizes a raw data processor to execute a first color processing on sensing values sensed by a red pixel, a green pixel, a blue pixel, and an IR pixel of each bayer pattern unit of a plurality of bayer pattern units included in the RGB-IR sensor respectively to generate gray levels corresponding to the red pixel, the green pixel, the blue pixel, and the IR pixel of the each bayer pattern unit, respectively, utilizes an interpolator to generate interpolation values of a red color component, a green color component, a blue color component, and an IR component of each pixel of the red pixel, the green pixel, the blue pixel, and the IR pixel of the each bayer pattern unit according to gray levels of red pixels, green pixels, blue pixels, and IR pixels located in predetermined positions of the plurality of bayer pattern units, utilizes a processor to execute a second color processing on the interpolation values of the red color component, the green color component, the blue color component, and the IR component of the each pixel of the red pixel, the green pixel, the blue pixel, and the IR pixel of the each bayer pattern unit to generate processed interpolation values corresponding to the each pixel of the red pixel, the green pixel, the blue pixel, and the IR pixel of the each bayer pattern unit, and utilizes a color corrector to generate correction values of the red color component, the green color component, and the blue color component of the each pixel of the red pixel, the green pixel, the blue pixel, and the IR pixel of the each bayer pattern unit according to the correction matrix corresponding to the each pixel of the red pixel, the green pixel, the blue pixel, and the IR pixel of the each bayer pattern unit and the interpolation values of the red color component, the green color component, the blue color component, and the IR component of the each pixel of the red pixel, the green pixel, the blue pixel, and the IR pixel of the each bayer pattern unit. Because the IR component of the each pixel of the red pixel, the green pixel, the blue pixel, and the IR pixel of the each bayer pattern unit cannot be filtered by all the raw data processor, the interpolator, the processor, and the color corrector, images generated by the image processing device according to the plurality of bayer pattern units do not have disadvantages of low color saturation and missing some colors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating pixels included in an RGB-IR sensor being arranged into a plurality of bayer pattern units.

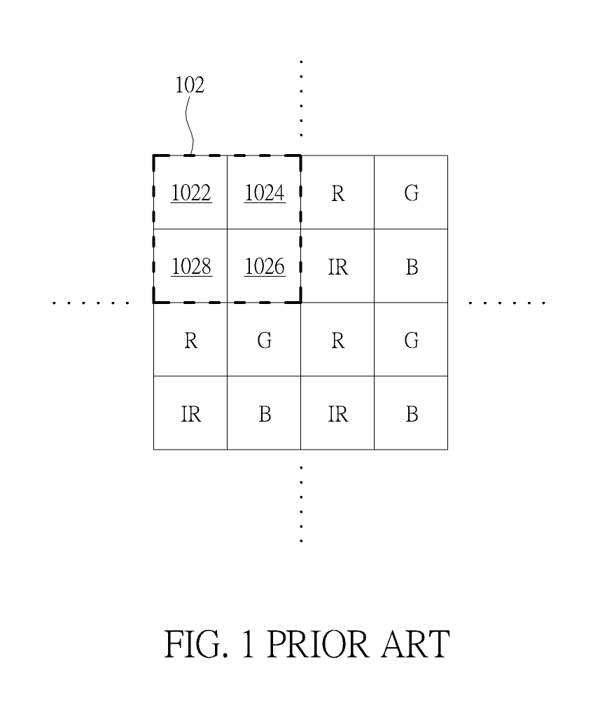

FIG. 2 is a diagram illustrating an image processing device 200 applied to an RGB-IR sensor according to a first embodiment of the present invention.

FIG. 3 is a diagram illustrating the interpolator generating interpolation values of a red color component, a green color component, a blue color component, and an IR component of each pixel of a red pixel, a green pixel, a blue pixel, and an IR pixel of each bayer pattern unit of the plurality of bayer pattern units according to gray levels of red pixels, green pixels, blue pixels, and IR pixels located in predetermined positions of the plurality of bayer pattern units.

FIG. 4 is a flowchart illustrating an image processing method applied to an RGB-IR sensor according to a second embodiment of the present invention.

### DETAILED DESCRIPTION

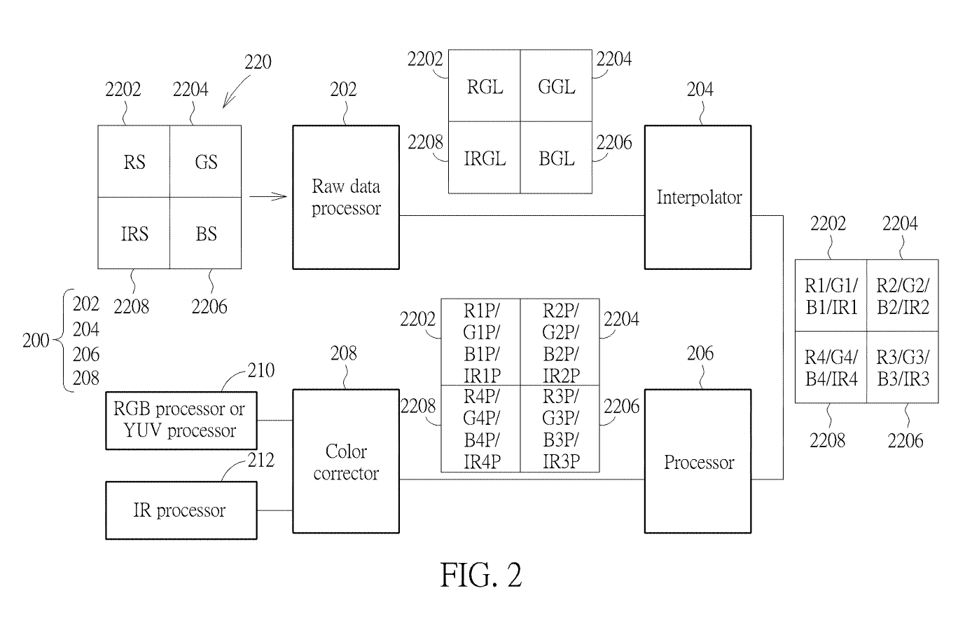

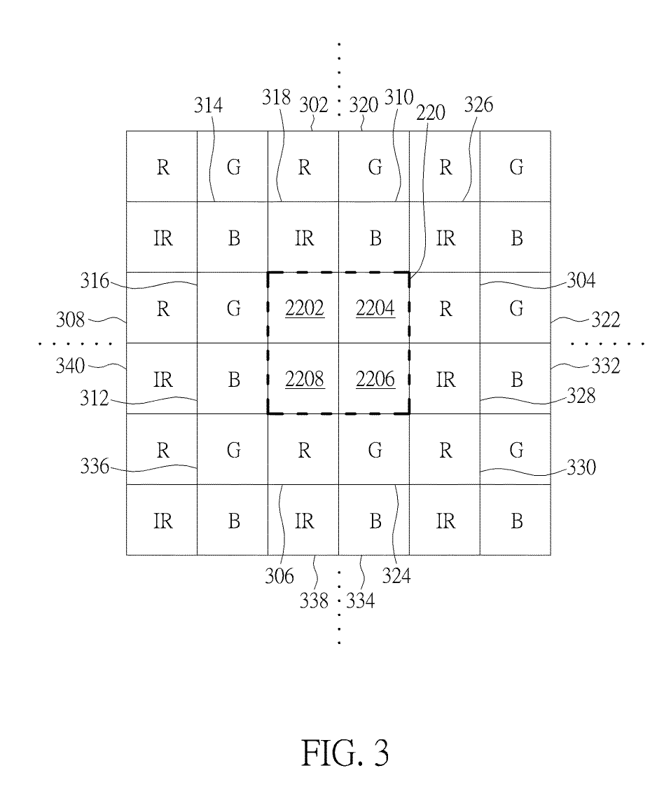

Please refer to FIG. 2. FIG. 2 is a diagram illustrating an image processing device 200 applied to an RGB-IR sensor according to a first embodiment of the present invention, wherein the image processing device 200 includes a raw data processor 202, an interpolator 204, a processor 206, and a color corrector 208, the raw data processor 202 is coupled to the interpolator 204, the processor 206 is coupled between the interpolator 204 and the color corrector 208, and the RGB-IR sensor does not have an IR filtering function. In addition, pixels included in the RGB-IR sensor are arranged into a plurality of bayer pattern units, and each bayer pattern unit of the plurality of bayer pattern units includes a red pixel, a green pixel, a blue pixel, and an IR pixel. As shown in FIG. 2, when a red pixel 2202, a green pixel 2204, a blue pixel 2206, and an IR pixel 2208 included in a bayer pattern unit 220 generate sensing values RS, GS, BS, IRS respectively, the raw data processor 202 is used for executing a first color processing on the sensing values RS, GS, BS, IRS respectively to generate gray levels RGL, GGL, BGL, IRGL corresponding to the red pixel 2202, the green pixel 2204, the blue pixel 2206, and the IR pixel 2208, respectively, wherein the first color processing includes at least one of a color shift processing, a color gain processing, a color de-noise processing, and a lens shading correction. After the raw data processor 202 generates the gray levels RGL, GGL, BGL, IRGL, the interpolator 204 can generate interpolation values of a red color component, a green color component, a blue color component, and an IR component of each pixel of the red pixel 2202, the green pixel 2204, the blue pixel 2206, and the IR pixel 2208 according to gray levels of red pixels, green pixels, blue pixels, and IR pixels located in predetermined positions of the plurality of bayer pattern units. For example, the interpolator 204 can generate the interpolation values of the red color component, the green color component, the blue color component, and the IR component of the each pixel of the red pixel 2202, the green pixel 2204, the blue pixel 2206, and the IR pixel 2208 according to gray levels of pixels included in the plurality of bayer pattern units adjacent to the each pixel of the red pixel 2202, the green pixel 2204, the blue pixel 2206, and the IR pixel 2208, or gray levels of pixels included in the plurality of bayer pattern units surrounding the each pixel of the red pixel 2202, the green pixel 2204, the blue pixel 2206, and the IR pixel 2208; further, in another embodiment of the present invention, the interpolator 204 can generate the interpolation values of the red color component, the green color component, the blue color component, and the IR component of the each pixel according to gray levels of the each pixel and the pixels included in the plurality of bayer pattern units adjacent to the each pixel, or gray levels of the each pixel and pixels included in the plurality of bayer pattern units surrounding the each pixel. For example, as shown in FIG. 3, the interpolator 204 can generate an interpolation value R1 of a red color component of the red pixel 2202 according to gray levels of red pixels 302, 304, 306, 308 and the red pixel 2202, an interpolation value B1 of a blue color component of the red pixel 2202 according to gray levels of blue pixels 310, 312, 314 and the blue pixel 2206, an interpolation value G1 of a green color component of the red pixel 2202 according to gray levels of a green pixel 316 and the green pixel 2204, and an interpolation value IR1 of an IR component of the red pixel 2202 according to gray levels of the IR pixel 2208 and an IR pixel 318; the interpolator 204 can generate an interpolation value R2 of a red color component of the green pixel 2204 according to the gray levels of the red pixels 304, 2202, an interpolation value B2 of a blue color component of the green pixel 2204 according to the gray levels of the blue pixels 310, 2206, an interpolation value G2 of a green color component of the green pixel 2204 according to the gray levels of the green pixels 316, 2204 and gray levels of green pixels 320, 322, 324, and an interpolation value IR2 of an IR component of the green pixel 2204 according to the gray levels of the IR pixels 318, 2208 and gray levels of IR pixels 326, 328; the interpolator 204 can generate an interpolation value R3 of a red color component of the blue pixel 2206 according to the gray levels of the red pixels 2202, 304, 306 and a gray level of a red pixel 330, an interpolation value B3 of a blue color component of the blue pixel 2206 according to the gray levels of the blue pixels 310, 312, 2206 and gray levels of blue pixels 332, 334, an interpolation value G3 of a green color component of the blue pixel 2206 according to the gray levels of the green pixels 324, 2204, and an interpolation value IR3 of an IR component of the blue pixel 2206 according to the gray levels of IR pixels 328, 2208; and the interpolator 204 can generate an interpolation value R4 of a red color component of the IR pixel 2208 according to the gray levels of the red pixels 2202, 306, an interpolation value B4 of a blue color component of the IR pixel 2208 according to the gray levels of the blue pixels 312, 2206, an interpolation value G4 of a green color component of the IR pixel 2208 according to the gray levels of the green pixels 324, 316, 2204 and a gray level of a green pixel 336, and an interpolation value IR4 of an IR component of the IR pixel 2208 according to the gray levels of the IR pixels 318, 328, 2208 and gray levels of IR pixels 338, 340. But, the present invention is not limited to the above mentioned method for the interpolator 204 generating the interpolation values of the red color component, the blue color component, the green color component, and the IR component of the each pixel of the red pixel 2202, the green pixel 2204, the blue pixel 2206, and the IR pixel 2208.

As shown in FIG. 2, after the interpolator 204 generates the interpolation values R1/G1/B1/IR1 of the red color component, the blue color component, the green color component, and the IR component of the red pixel 2202, the interpolation values R2/G2/B2/IR2 of the red color component, the blue color component, the green color component, and the IR component of the green pixel 2204, the interpolation values R3/G3/B3/IR3 of the red color component, the blue color component, the green color component, and the IR component of the blue pixel 2206, and the interpolation values R4/G4/B4/IR4 of the red color component, the blue color component, the green color component, and the IR component of the IR pixel 2208, the processor 206 can execute a second color processing on the interpolation values R1/G1/B1/IR1, R2/G2/B2/IR2, R3/G3/B3/IR3, R4/G4/B4/IR4 to generate processed interpolation values corresponding to the each pixel of the red pixel 2202, the green pixel 2204, the blue pixel 2206, and the IR pixel 2208 (that is, processed interpolation values R1P/G1P/B1P/IR1P corresponding to the red pixel 2202, processed interpolation values R2P/G2P/B2P/IR2P corresponding to the green pixel 2204, processed interpolation values R3P/G3P/B3P/IR3P corresponding to the blue pixel 2206, and processed interpolation values R4P/G4P/B4P/IR4P corresponding to the IR pixel 2208), wherein the second color processing includes at least one of a color shift processing, a color gain processing, a color de-noise processing, and a lens shading correction.

After the processor 206 generates the processed interpolation values R1P/G1P/B1P/IR1P corresponding to the red pixel 2202, the color corrector 208 can determine a correction matrix corresponding to the red pixel 2202 according to the processed interpolation values R1P/G1P/B1P/IR1P corresponding to the red pixel 2202, target values RT1/GT1/BT1 of the red color component, the green color component, and the blue color component of the red pixel 2202, and equation (1):

$$[ \begin{matrix}RT 1 \\ GT 1 \\ BT 1\end{matrix} ] = [ \begin{matrix}R 11 & R 12 & R 13 & R 14 & R 15 \\ R 21 & R 22 & R 23 & R 24 & R 25 \\ R 31 & R 32 & R 33 & R 34 & R 35\end{matrix} ] [ \begin{matrix}R 1 P \\ G 1 P \\ B 1 P \\ IR 1 P \\ 1\end{matrix} ] \qquad ( 1 )$$

As shown in equation (1), because the target values RT1/GT1/BT1 of the red color component, the green color component, and the blue color component of the red pixel 2202 and the processed interpolation values R1P/G1P/B1P/IR1P corresponding to the red pixel 2202 are known, the correction matrix

$$[ \begin{matrix}R 11 & R 12 & R 13 & R 14 & R 15 \\ R 21 & R 22 & R 23 & R 24 & R 25 \\ R 31 & R 32 & R 33 & R 34 & R 35\end{matrix} ]$$

corresponding to the red pixel 2202 can be determined by equation (1), wherein R11, R12, R13, R14, R15, R21, R22, R23, R24, R25, R31, R32, R33, R34, R35 are coefficients of the correction matrix

$$[ \begin{matrix}R 11 & R 12 & R 13 & R 14 & R 15 \\ R 21 & R 22 & R 23 & R 24 & R 25 \\ R 31 & R 32 & R 33 & R 34 & R 35\end{matrix} ]$$

corresponding to the red pixel 2202. Because the RGB-IR sensor includes the plurality of bayer pattern units, the correction matrix

$$[ \begin{matrix}R 11 & R 12 & R 13 & R 14 & R 15 \\ R 21 & R 22 & R 23 & R 24 & R 25 \\ R 31 & R 32 & R 33 & R 34 & R 35\end{matrix} ]$$

corresponding to the red pixel 2202 can also be applied to red pixels of other bayer pattern units of the RGB-IR sensor. Therefore, the color corrector 208 can generate correction values RC/GC/BC of a red color component, a green color component, and a blue color component of a red pixel of a bayer pattern unit of the RGB-IR sensor according to the correction matrix

$$[ \begin{matrix}R 11 & R 12 & R 13 & R 14 & R 15 \\ R 21 & R 22 & R 23 & R 24 & R 25 \\ R 31 & R 32 & R 33 & R 34 & R 35\end{matrix} ]$$

corresponding to the red pixel 2202, processed interpolation values RP/GP/BP/IRP corresponding to the red pixel of the bayer pattern unit of the RGB-IR sensor, and equation (2) :

$$[ \begin{matrix}RC \\ GC \\ BC\end{matrix} ] = [ \begin{matrix}R 11 & R 12 & R 13 & R 14 & R 15 \\ R 21 & R 22 & R 23 & R 24 & R 25 \\ R 31 & R 32 & R 33 & R 34 & R 35\end{matrix} ] [ \begin{matrix}RP \\ G P \\ B P \\ IR P \\ 1\end{matrix} ] \qquad ( 2 )$$

Further, the color corrector 208 can generate a correction matrix corresponding to each pixel of the green pixel 2204, the blue pixel 2206, and the IR pixel 2208 according to the above mentioned same operational principle, so further description thereof is omitted for simplicity. Further, after the color corrector 208 generates correction values of a red color component, a green color component, and a blue color component of each pixel of the red pixel, the green pixel, the blue pixel, and the IR pixel of the bayer pattern unit of the RGB-IR sensor, the correction values of the red color component, the green color component, and the blue color component of the each pixel of the red pixel, the green pixel, the blue pixel, and the IR pixel of the bayer pattern unit can be transmitted to an RGB processor or YUV processor 210 to be processed, and processed interpolation values corresponding to an IR component of the each pixel of the red pixel, the green pixel, the blue pixel, and the IR pixel of the bayer pattern unit can be transmitted to an IR processor 212 to be processed.

Further, in another embodiment of the present invention, after the processor 206 generates the processed interpolation values R1P/G1P/B1P/IR1P corresponding to the red pixel 2202, the color corrector 208 can determine the correction matrix corresponding to the red pixel 2202 according to the processed interpolation values R1P/G1P/B1P/IR1P corresponding to the red pixel 2202, the target values RT1/GT1/BT1 of the red color component, the green color component, and the blue color component of the red pixel 2202, and equation (3):

$$[ \begin{matrix}RT 1 \\ GT 1 \\ BT 1\end{matrix} ] = [ \begin{matrix}R 11 & R 12 & R 13 & R 14 & R 15 & R 16 & R 17 & R 18 \\ R 21 & R 22 & R 23 & R 24 & R 25 & R 26 & R 27 & R 28 \\ R 31 & R 32 & R 33 & R 34 & R 35 & R 36 & R 37 & R 38\end{matrix} ] [ \begin{matrix}R 1 P \\ G 1 P \\ B 1 P \\ IR 1 P \\ R 1 P * IR 1 P \\ G 1 P * IR 1 P \\ B 1 P * IR 1 P \\ 1\end{matrix} ] \qquad ( 3 )$$

As shown in equation (3), R11, R12, R13, R14, R15, R16, R17, R18, R21, R22, R23, R24, R25, R26, R27, R28, R31, R32, R33, R34, R35, R36, R37, R38 are coefficients of the correction matrix

$$[ \begin{matrix}R 11 & R 12 & R 13 & R 14 & R 15 & R 16 & R 17 & R 18 \\ R 21 & R 22 & R 23 & R 24 & R 25 & R 26 & R 27 & R 28 \\ R 31 & R 32 & R 33 & R 34 & R 35 & R 36 & R 37 & R 38\end{matrix} ]$$

corresponding to the red pixel 2202. Further, the present invention is not limited to the correction matrixes

$$[ \begin{matrix}R 11 & R 12 & R 13 & R 14 & R 15 \\ R 21 & R 22 & R 23 & R 24 & R 25 \\ R 31 & R 32 & R 33 & R 34 & R 35\end{matrix} ] , [ \begin{matrix}R 11 & R 12 & R 13 & R 14 & R 15 & R 16 & R 17 & R 18 \\ R 21 & R 22 & R 23 & R 24 & R 25 & R 26 & R 27 & R 28 \\ R 31 & R 32 & R 33 & R 34 & R 35 & R 36 & R 37 & R 38\end{matrix} ]$$

corresponding to the red pixel 2202 shown equation (1) and equation (3), respectively. That is to say, the present invention can also utilize other equations to generate a correction matrix corresponding to the red pixel 2202 through the target values RT1/GT1/BT1 of the red color component, the green color component, and the blue color component of the red pixel 2202 and the processed interpolation values R1P/G1P/B1P/IR1P corresponding to the red pixel 2202.

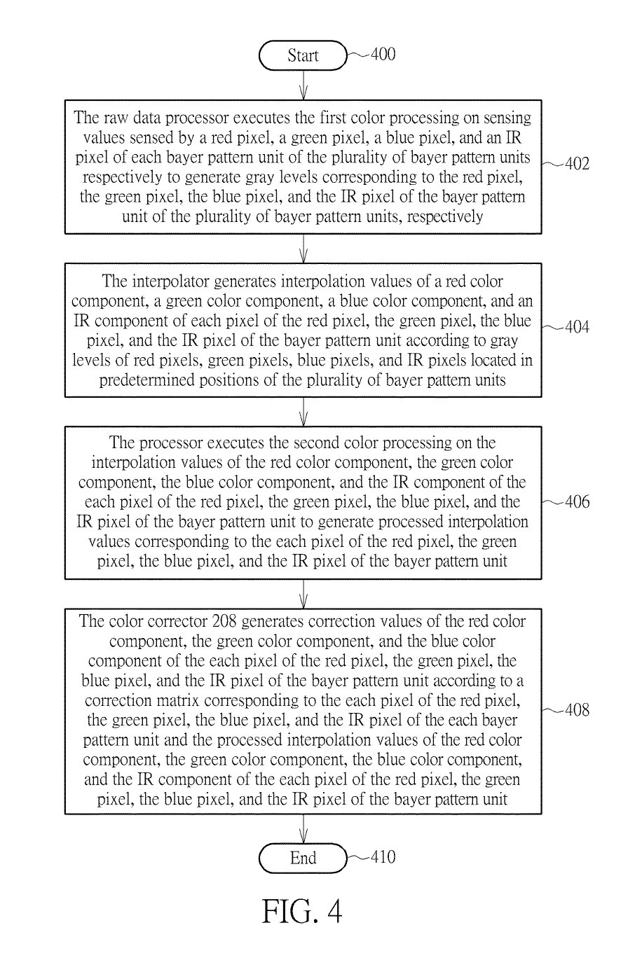

Please refer to FIGS. 2-4. FIG. 4 is a flowchart illustrating an image processing method applied to an RGB-IR sensor according to a second embodiment of the present invention. The image processing method in FIG. 4 is illustrated using the image processing device 200 in FIG. 2. Detailed steps are as follows:

Step 400: Start.

Step 402: The raw data processor 202 executes the first color processing on sensing values sensed by a red pixel, a green pixel, a blue pixel, and an IR pixel of each bayer pattern unit of the plurality of bayer pattern units respectively to generate gray levels corresponding to the red pixel, the green pixel, the blue pixel, and the IR pixel of the bayer pattern unit of the plurality of bayer pattern units, respectively.

Step 404: The interpolator 204 generates interpolation values of a red color component, a green color component, a blue color component, and an IR component of each pixel of the red pixel, the green pixel, the blue pixel, and the IR pixel of the bayer pattern unit according to gray levels of red pixels, green pixels, blue pixels, and IR pixels located in predetermined positions of the plurality of bayer pattern units.

Step 406: The processor 206 executes the second color processing on the interpolation values of the red color component, the green color component, the blue color component, and the IR component of the each pixel of the red pixel, the green pixel, the blue pixel, and the IR pixel of the bayer pattern unit to generate processed interpolation values corresponding to the each pixel of the red pixel, the green pixel, the blue pixel, and the IR pixel of the bayer pattern unit.

Step 408: The color corrector 208 generates correction values of the red color component, the green color component, and the blue color component of the each pixel of the red pixel, the green pixel, the blue pixel, and the IR pixel of the bayer pattern unit according to a correction matrix corresponding to the each pixel of the red pixel, the green pixel, the blue pixel, and the IR pixel of the each bayer pattern unit and the processed interpolation values of the red color component, the green color component, the blue color component, and the IR component of the each pixel of the red pixel, the green pixel, the blue pixel, and the IR pixel of the bayer pattern unit.

Step 410: End.

In Step 402, as shown in FIG. 2, when the red pixel 2202, the green pixel 2204, the blue pixel 2206, and the IR pixel 2208 included in the bayer pattern unit 220 generate the sensing values RS, GS, BS, IRS, respectively, the raw data processor 202 can execute the first color processing on the sensing values RS, GS, BS, IRS respectively to generate the gray levels RGL, GGL, BGL, IRGL corresponding to the red pixel 2202, the green pixel 2204, the blue pixel 2206, and the IR pixel 2208, respective. In Step 404, after the raw data processor 202 generates the gray levels RGL, GGL, BGL, IRGL, the interpolator 204 can generate the interpolation values of the red color component, the green color component, the blue color component, and the IR component of the each pixel of the red pixel 2202, the green pixel 2204, the blue pixel 2206, and the IR pixel 2208 according to the gray levels of the red pixels, the green pixels, the blue pixels, and the IR pixels located in the predetermined positions of the plurality of bayer pattern units. For example, as shown in FIG. 3, the interpolator 204 can generate the interpolation value R1 of the red color component of the red pixel 2202 according to the gray levels of the red pixels 302, 304, 306, 308, 2202, the interpolation value B1 of the blue color component of the red pixel 2202 according to the gray levels of the blue pixels 310, 312, 314, 2206, the interpolation value G1 of the green color component of the red pixel 2202 according to the gray levels of the green pixel 2204, 316, and the interpolation value IR1 of the IR component of the red pixel 2202 according to the gray levels of the IR pixel 2208, 318. Further, the interpolator 204 can generate the interpolation values R2/G2/B2/IR2 of the red color component, the blue color component, the green color component, and the IR component of the green pixel 2204, the interpolation values R3/G3/B3/IR3 of the red color component, the blue color component, the green color component, and the IR component of the blue pixel 2206, and the interpolation values R4/G4/B4/IR4 of the red color component, the blue color component, the green color component, and the IR component of the IR pixel 2208 according to the same principles of the interpolator 204 generating the interpolation values R1/G1/B1/IR1 of the red color component, the blue color component, the green color component, and the IR component of the red pixel 2202.

In Step 406, after the interpolator 204 generates the interpolation values R1/G1/B1/IR1, R2/G2/B2/IR2, R3/G3/B3/IR3, R4/G4/B4/IR4, the processor 206 can execute the second color processing on the interpolation values R1/G1/B1/IR1, R2/G2/B2/IR2, R3/G3/B3/IR3, R4/G4/B4/IR4 to generate the processed interpolation values corresponding to the each pixel of the red pixel 2202, the green pixel 2204, the blue pixel 2206, and the IR pixel 2208 (that is, the processed interpolation values R1P/G1P/B1P/IR1P corresponding to the red pixel 2202, the processed interpolation values R2P/G2P/B2P/IR2P corresponding to the green pixel 2204, the processed interpolation values R3P/G3P/B3P/IR3P corresponding to the blue pixel 2206, and the processed interpolation values R4P/G4P/B4P/IR4P corresponding to the IR pixel 2208).

In Step 408, after the processor 206 generates the processed interpolation values R1P/G1P/B1P/IR1P corresponding to the red pixel 2202, the color corrector 208 can determine the correction matrix corresponding to the red pixel 2202 according to the processed interpolation values R1P/G1P/B1P/IR1P corresponding to the red pixel 2202, the target values RT1/GT1/BT1 of the red color component, the green color component, and the blue color component of the red pixel 2202, and equation (1). Because the RGB-IR sensor includes the plurality of bayer pattern units, the correction matrix

$$[ \begin{matrix}R 11 & R 12 & R 13 & R 14 & R 15 \\ R 21 & R 22 & R 23 & R 24 & R 25 \\ R 31 & R 32 & R 33 & R 34 & R 35\end{matrix} ]$$

corresponding to the red pixel 2202 can also be applied to red pixels of other bayer pattern units of the RGB-IR sensor.

Further, after the color corrector 208 generates the correction values of the red color component, the green color component, and the blue color component of the each pixel of the red pixel, the green pixel, the blue pixel, and the IR pixel of the bayer pattern unit, the correction values of the red color component, the green color component, and the blue color component of the each pixel of the red pixel, the green pixel, the blue pixel, and the IR pixel of the bayer pattern unit can be transmitted to the RGB processor or YUV processor 210 to be processed, and the processed interpolation values corresponding to the IR component of the each pixel of the red pixel, the green pixel, the blue pixel, and the IR pixel of the bayer pattern unit can be transmitted to the IR processor 212 to be processed.

To sum up, because the present invention utilizes the raw data processor to execute the first color processing on the sensing values sensed by the red pixel, the green pixel, the blue pixel, and the IR pixel of the bayer pattern unit of the plurality of bayer pattern units respectively to generate the gray levels corresponding to the red pixel, the green pixel, the blue pixel, and the IR pixel of the bayer pattern unit, respectively, utilizes the interpolator to generate the interpolation values of the red color component, the green color component, the blue color component, and the IR component of the each pixel of the red pixel, the green pixel, the blue pixel, and the IR pixel of the bayer pattern unit according to the gray levels of the red pixels, the green pixels, the blue pixels, and the IR pixels located in the predetermined positions of the plurality of bayer pattern units, utilizes the processor to execute the second color processing on the interpolation values of the red color component, the green color component, the blue color component, and the IR component of the each pixel of the red pixel, the green pixel, the blue pixel, and the IR pixel of the bayer pattern unit to generate the processed interpolation values corresponding to the each pixel of the red pixel, the green pixel, the blue pixel, and the IR pixel of the bayer pattern unit, and utilizes the color corrector to generate the correction values of the red color component, the green color component, and the blue color component of the each pixel of the red pixel, the green pixel, the blue pixel, and the IR pixel of the bayer pattern unit according to the correction matrix corresponding to the each pixel of the red pixel, the green pixel, the blue pixel, and the IR pixel of the bayer pattern unit and the interpolation values of the red color component, the green color component, the blue color component, and the IR component of the each pixel of the red pixel, the green pixel, the blue pixel, and the IR pixel of the bayer pattern unit. Because the IR component of the each pixel of the red pixel, the green pixel, the blue pixel, and the IR pixel of the bayer pattern unit can be processed by all the raw data processor, the interpolator, the processor, and the color corrector, images generated by the image processing device according to the plurality of bayer pattern units do not have disadvantages of low color saturation and missing some colors.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing device applied to an RGB-IR sensor, wherein pixels comprised in the RGB-IR sensor are arranged into a plurality of bayer pattern units, and each bayer pattern unit of the plurality of bayer pattern units comprises a red pixel, a green pixel, a blue pixel, and an IR pixel, the image processing device comprising:
an interpolator generating interpolation values of a red color component, a green color component, a blue color component, and an IR component of each pixel of the each bayer pattern unit according to gray levels of red pixels, green pixels, blue pixels, and IR pixels located in predetermined positions of the plurality of bayer pattern units; and
a color corrector generating correction values of the red color component, the green color component, and the blue color component of the each pixel according to a correction matrix corresponding to the each pixel and the interpolation values of the red color component, the green color component, the blue color component, and the IR component of the each pixel, wherein the correction matrix corresponds to the interpolation values of the red color component, the green color component, the blue color component, and the IR component of the each pixel and target values of the red color component, the green color component, and the blue color component of the each pixel.

2. The image processing device of claim 1, further comprising:
a raw data processor coupled to the interpolator, wherein the raw data processor executes a first color processing on sensing values sensed by the red pixel, the green pixel, the blue pixel, and the IR pixel comprised in the each bayer pattern unit respectively to generate gray levels corresponding to the red pixel, the green pixel, the blue pixel, and the IR pixel comprised in the each bayer pattern unit, respectively.

3. The image processing device of claim 2, wherein the first color processing comprises at least one of a color shift processing, a color gain processing, a color de-noise processing, and a lens shading correction.

4. The image processing device of claim 1, further comprising:
a processor coupled between the interpolator and the color corrector, wherein the processor executes a second color processing on the interpolation values of the red color component, the green color component, the blue color component, and the IR component of the each pixel to generate processed interpolation values corresponding to the each pixel, wherein the color corrector generates the correction values of the red color component, the green color component, and the blue color component of the each pixel according to the correction matrix and the processed interpolation values, and the correction matrix corresponds to the processed interpolation values and the target values of the red color component, the green color component, and the blue color component of the each pixel.

5. The image processing device of claim 4, wherein the second color processing comprises at least one of a color shift processing, a color gain processing, a color de-noise processing, and a lens shading correction.

6. An image processing method applied to an RGB-IR sensor, wherein pixels comprised in the RGB-IR sensor are arranged into a plurality of bayer pattern units, each bayer pattern unit of the plurality of bayer pattern units comprises a red pixel, a green pixel, a blue pixel, and an IR pixel, and an image processing device applied to the image processing method comprises an interpolator and a color corrector, the image processing method comprising:
the interpolator generating interpolation values of a red color component, a green color component, a blue color component, and an IR component of each pixel of the each bayer pattern unit according to gray levels of red pixels, green pixels, blue pixels, and IR pixels located in predetermined positions of the plurality of bayer pattern units; and
the color corrector generating correction values of the red color component, the green color component, and the blue color component of the each pixel according to a correction matrix corresponding to the each pixel and the interpolation values of the red color component, the green color component, the blue color component, and the IR component of the each pixel, wherein the correction matrix corresponds to the interpolation values of the red color component, the green color component, the blue color component, and the IR component of the each pixel and target values of the red color component, the green color component, and the blue color component of the each pixel.

7. The image processing method of claim 6, further comprising:
a raw data processor further comprised in the image processing device executing a first color processing on sensing values sensed by the red pixel, the green pixel, the blue pixel, and the IR pixel comprised in the each bayer pattern unit respectively to generate gray levels corresponding to the red pixel, the green pixel, the blue pixel, and the IR pixel comprised in the each bayer pattern unit, respectively.

8. The image processing method of claim 7, wherein the first color processing comprises at least one of a color shift processing, a color gain processing, a color de-noise processing, and a lens shading correction.

9. The image processing method of claim 6, further comprising:
a processor further comprised in the image processing device executing a second color processing on the interpolation values of the red color component, the green color component, the blue color component, and the IR component of the each pixel to generate processed interpolation values corresponding to the each pixel, wherein the color corrector generates the correction values of the red color component, the green color component, and the blue color component of the each pixel according to the correction matrix and the processed interpolation values, and the correction matrix corresponds to the processed interpolation values and the target values of the red color component, the green color component, and the blue color component of the each pixel.

10. The image processing method of claim 9, wherein the second color processing comprises at least one of a color shift processing, a color gain processing, a color de-noise processing, and a lens shading correction.
